(19) United States
(12) Patent Application Publication
(10) Pub. No.: US 2005/0180630 A1
(43) Pub. Date: Aug. 18, 2005

(54) Scalable encoding method of color histogram

(75) Inventors: Jin Soo Lee, Seoul (KR); Heon Jun Kim, Seoul (KR); Jung Min Song, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/012,725

(22) Filed: Dec. 16, 2004

Related U.S. Application Data
(63) Continuation of application No. 09/906,821, filed on Jul. 18, 2001, now abandoned.
(63) Continuation of application No. 09/906,832, filed on Jul. 18, 2001, now Pat. No. 6,608,936.

(30) Foreign Application Priority Data
Jul. 19, 2000 (KR) 41456/2000

(51) Int. Cl. G06K 9/00; G06K 9/36

(52) U.S. Cl. 382/170; 382/166

(57) ABSTRACT

Disclosed is a scalable encoding method of a color histogram that produces an initial color histogram of relatively upper quantization level and produces a color histogram of relatively lower level using the initial color histogram. The scalable color histogram encoding method according to the present invention includes producing initial color histogram bins of the relatively upper level, and producing color histogram bins of relatively lower level by applying predetermined operators to the color histogram bins of the upper level, wherein the relatively upper level of color histogram bins including dummy bins and the relatively lower level of color histogram bins modified and produced from the upper level of color histogram bins at each intermediate encoding step have different encoding depths.

### BACKGROUND OF THE INVENTION

1. Field of the Invention

The present invention relates to a color descriptor used in a multimedia search applying color information. In particular, the present invention relates to a scalable encoding method of a color histogram and a method of matching the color histogram quantized by this encoding method.

2. Description of the Related Art

Recently, with the introduction of contents-based multimedia search techniques, researches for multimedia features that affect performance of the search have actively been made. Most of search engines use global or local color information, texture information, etc., as a feature element for an image search, and the color information is known as the most important element for the image search. Accordingly, many researchers are trying to develop more effective color features and more effective color space for the image search.

Most widely used color information is a color histogram. The color histogram is information that represents the color distribution of multimedia data such as an image, and the number of color histogram bins is determined based upon how the color space is quantized.

In general, if the color histogram is quantized in more detail and expressed by a greater number of bins, the search performance can be improved. But, it takes more time to perform the search since the size of the histogram is increased. Especially, in case of the search through a network, the increased size of the histogram may act as an important factor because of limited capacity of the network.

Meanwhile, if the histogram of the data to be searched is interrupted during its transmission due to network problems and the search is performed by only the transmitted portion of the histogram, the search performance can be seriously deteriorated.

### SUMMARY OF THE INVENTION

Therefore, an object of the invention is to solve the above problems and/or disadvantages and to provide at least the advantages described hereinafter.

An object of the present invention is to provide a scalable encoding method of a color histogram and a method of matching the color histogram encoded by this encoding method.

It is another object of the present invention is to provide a scalable encoding method of a color histogram and a method of matching the encoded color histogram , which can perform a progressive matching of the color histogram with a given number of bits without deteriorating performance of search.

It is still another object of the present invention is to provide a scalable encoding method of a color histogram and a method of matching the encoded color histogram, wherein encoding depths of the color histograms modified and produced at each step are different one another.

Further object of the present invention is to provide a scalable encoding method of a color histogram and a method of matching the encoded color histogram, which can facilitate the encoding of the color histogram by adding dummy bins to the color histogram bins of a relatively high quantization level.

Still another further object of the present invention is to provide an effective color histogram encoding method that the search performance is not deteriorated even if transmission of color histogram is interrupted.

In one aspect of the present invention, the scalable encoding method of a color histogram comprises: producing initial color histogram bins of a relatively upper level; and producing color histogram bins of a relatively lower level by applying predetermined operators to the color histogram bins of the upper level; wherein the upper level of color histogram bins and the lower level of color histogram modified and produced from the upper level of color histogram at each intermediate encoding step have different encoding depths.

According to the present invention, dummy bins are added to the initial color histogram bins of the upper level for applying a scalable encoding scheme.

In another aspect of the present invention, there is provided a method of matching a scalable-encoded color histogram in a multimedia search using the color histogram, the method comprising: comparing bins of whole query image and bins of whole target image and obtaining the difference there between; constructing subsets based upon the obtained differences; and constructing the scalable-encoded color histogram in the form of a progressive bit stream, starting from its lower level through upper level.

### BRIEF DESCRIPTION OF THE DRAWINGS

The invention will be described in detail with reference to the following drawings in which like reference numerals refer to like elements wherein:

FIG. 1 is a view explaining the scalable encoding method of a color histogram according to the present invention;

FIG. 2 is a view illustrating an example of the scalable encoding method of a color histogram according to the present invention; and

FIG. 3 is a view illustrating an example of a quantization table according to the encoding method of FIG. 1.

### DETAILED DESCRIPTION OF THE PREFERRED EMBODIMENT

Hereinafter, preferred embodiments of the present invention will be described in detail.

A scalable encoding method of a color histogram and a method of matching the scalable-encoded color histogram according to the present invention will be described with respect to a preferred embodiment illustrated in the annexed drawings.

According to the present invention, a color histogram is scalable-encoded to perform a progressive matching with a given number of bits without deteriorating the performance.

The color histogram is determined by the color quantization. In other words, the number of color quantization is equal to the number of color histogram bins. A high-level color quantization is performed based on a low-level color quantization, and thus different quantization numbers can be obtained in a scalable manner.

At this time, the number of bins is determined according to the mutually scalable color quantization to produce the color histogram, and since the histogram bins having different bin numbers are mutually scalable, they can be compared with one another without loss.

In order to use such a scalability of the histogram bins, color histogram is encoded by applying an addition operator and a subtraction operator to an initial color histogram based upon the mutually scalable quantization method.

Specifically, this encoding method performs an encoding by simulating the scalable quantization method. Thus, when the encoding is finished, encoded coefficients having the same number as the bin number of the initial histogram are produced, and subsets of the whole coefficient values are determined by the respective scalable quantization methods.

Here, the bin values of the initially used color histogram can be expressed by a uniform bin value quantization or a non-uniform bin value quantization.

The above-described encoded coefficients are quantized as follows.

The coefficients encoded through final step are uniform-quantized based upon the number of bits given by a quantization offset.

The quantization offset is obtained by analyzing a certain image dataset, and the dataset used at that time is to be made by constructing a dataset representative of a certain purpose. The offset can be determined by the number of bits assigned to the coefficients.

For example, a center value of the corresponding coefficient range of the whole dataset is used with respect to the coefficients less than specified bits is used, and a mean value of the corresponding coefficient values of the whole dataset is used with respect to other coefficients exceed the specified bits.

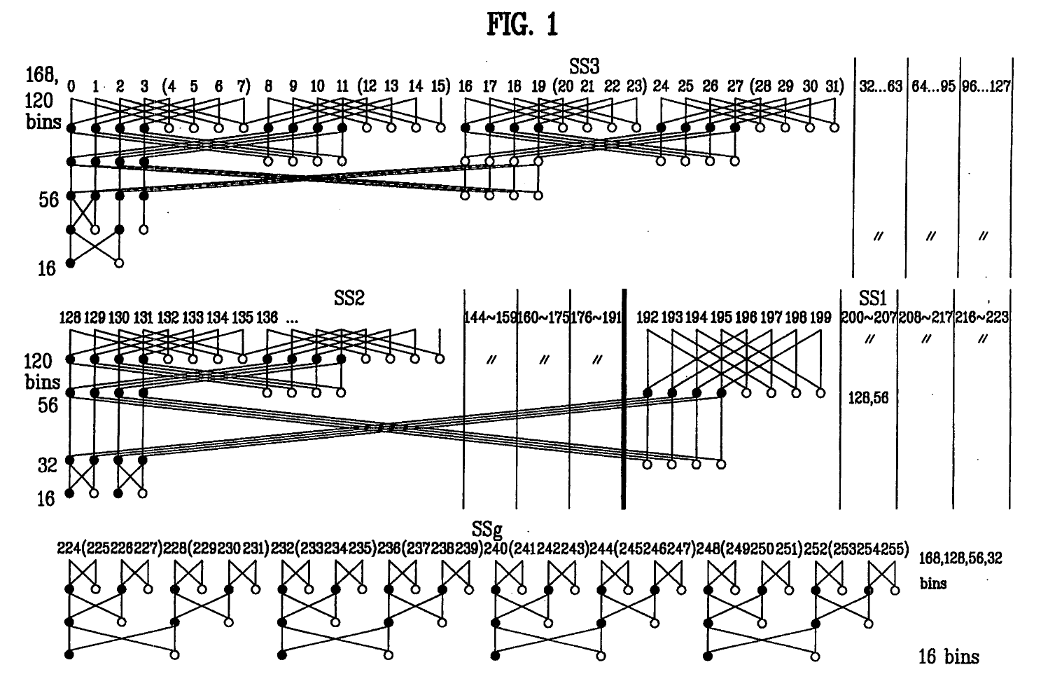

FIG. 1 is a view illustrating the scalable encoding method of color histograms according to an embodiment of the present invention, and shows an encoding method of HMMD color histogram.

In FIG. 1, black points represent results of addition (+) with respect to color histogram bins of a relatively upper level, and white points represent results of subtraction (−).

As shown in FIG. 1, the initial histogram is in the uppermost level in the HMMD color space having 256 bins (i.e., 0^{th} to 255^{th} bins).

Among the bin numbers (indices), the bin whose number is marked in parentheses represents a dummy bin, and the value of ‘0’ can be given thereto.

The first step of the scalable color histogram encoding method according to the present embodiment is to construct an initial color histogram.

The initial histogram is 168-bin HMMD color histogram with 4-bit non-uniform bin quantization. The reason of using 168 histogram bins instead of 256 bins is that present inventors have experienced this degree of quantization levels are usually enough in image retrieval.

To construct 168 bin HMMD color histogram, the HMMD color space is quantized non-uniformly as follows:

The whole HMMD color space is divided into 4 subspaces: SSg(subspace gray), SS1, SS2 and SS3. This subspace division is simply performed based on “chroma”(diff: colorfulness) parameter. At this time, the cut-points for subspaces SSg, SS1, SS2 and SS3 are set as 9,29,75, respectively when the range is 0 to 255. Therefore, above subspace division can be described as follows:

$$Color [ hue , intensity , chroma ] ∈ \{ \begin{matrix}SSg if 0 \leq chroma < 9 \\ SS1 if 9 \leq chroma < 29 \\ SS2 if 29 \leq chroma < 75 \\ SS3 if 75 \leq chroma \leq 255\end{matrix}$$

For the respective subspaces, the uniform color quantization is further applied to construct 168-bin color histogram as follows:

SSg: hue:1, chroma(diff):1, intensity(sum):8.

SS1: hue:8, chroma(diff):1, intensity(sum):4.

SS2: hue:16, chroma(diff):1, intensity(sum):4.

SS3: hue:16, chroma(diff):1, intensity(sum):4.

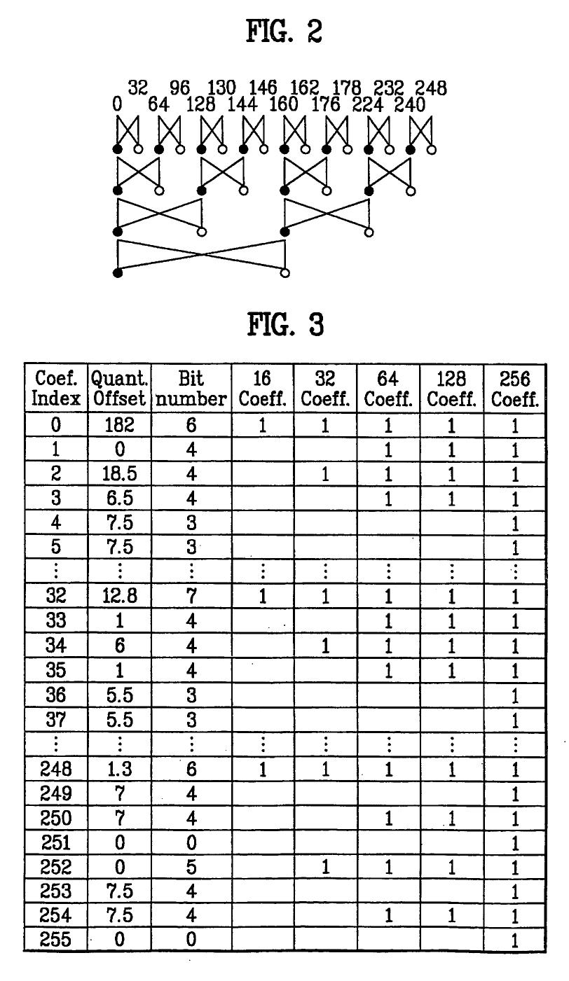

At the next step, this initial 168-bin histogram is applied to construct a scalable encoding scheme (See FIG. 2). To apply this scalable encoding scheme, 88(=256-168) dummy bins (0 values) are added, and thus the 168-bin histogram is considered as 256 values.

It is processed all the way down to 128, 64, 32 and 16 sum coefficients by the properly arranging index order which simulates 120, 56, 32 and 16-bin color histogram, respectively.

The positions of the dummy bins among 256 bins are given as follows.

int dum[256]=

[0,0,0,0,1,1,1,1,0,0,0,0,1,1,1,1,0,0,0,0,1,1,1,1,0,0,0,0,1,1 ,1,1,0,0,0,0,1,1,1,1,0,0,0,0,1,1,1,1,0,0,0,0,1,1,1,1,0,0,0,0,1,1,1 1,0,0,0,0,1,1,1,1,0,0,0,0,1,1,1,1,0,0,0,0,1,1,1,1,0,0,0,0,1,1,1,1 ,0,0,0,0,1,1,1,1,0,0,0,0,1,1,1,1,0,0,0,0,1,1,1,1,0,0,0,0,1,1,1,1,0 ,0,0,0,0,0,0,0,0,0,0,0,0,0,0,0,0,0,0,0,0,0,0,0,0,0,0,0,0,0,0,0,0,0 ,0,0,0,0,0,0,0,0,0,0,0,0,0,0,0,0,0,0,0,0,0,0,0,0,0,0,0,0,0,0,0,0,0 ,0,0,0,0,0,0,0,0,0,0,0,0,0,0,0,0,0,0,0,0,0,0,0,0,0,0,0,0,0,0,0,1,1 ,1,0,1,1,1,0,1,1,1,0,1,1,1,0,1,1,1,0,1,1,1,0,1,1,1,0,1,1,1].

Herein, the indices (i.e., bin numbers) are in the order of 0 to 255. The value of ‘1’ represents the position of the dummy bin, and the value of ‘0’ is given thereto as its value.

Each level of color histograms (120, 56, 32 and 16 bins) are described as follows:

120 histogram:

SSg: hue:1, chroma(diff):1, intensity(sum):8.

SS1: hue:4, chroma(diff):1, intensity(sum):4.

SS2: hue:8, chroma(diff):1, intensity(sum):4.

SS3: hue:16, chroma(diff):1, intensity(sum):4.

56 histogram:

SSg: hue:1, chroma(diff):1, intensity(sum):8.

SS1: hue:4, chroma(diff):1, intensity(sum):4.

SS2: hue:4, chroma(diff):1, intensity(sum):4.

SS3: hue:4, chroma(diff):1, intensity(sum):4.

32 histogram:

SSg: hue:1, chroma(diff):1, intensity(sum):8.

SS12: hue:4, chroma(diff):1, intensity(sum):4. (SS1 and SS2 are merged into SS12) SS3: hue:4, chroma(diff):1, intensity(sum):2.

16 histogram:

SSg: hue:1, chroma(diff):1, intensity(sum):4.

SS12: hue:4, chroma(diff):1, intensity(sum):2.

SS3: hue:4, chroma(diff):1, intensity(sum):1.

After the 16 sum coefficients are obtained, the 16 sum coefficients are further transformed completely without rearranging index order (See FIG. 2). Then, one sum coefficient and other 254 coefficients are finally obtained.

4-bit non-uniform bin value quantization applied for the initial 168 histogram is described as following code.

double Th0=0.0, Th1=0.6/310.0, Th2=20.0/310.0, Th3=85.0/310.0;
int QuantizedValue;
if (fpValue <= Th0)

QuantizedValue = 0;

else if(fpValue < Th1)

QuantizedValue = (int)(fpValue/Th1*2)+1;

else if(fpValue < Th2)

QuantizedValue = (int)((fpValue-Th1)/(Th2-Th1)*6)+3;

else if (fpValue < Th3)

QuantizedValue = (int)((fpValue-Th2)/(Th3-Th2)*6)+9;

else

QuantizedValue = 15;

where fpValue is a float bin value from 0 to 1.

The highest quantization level is presented by 168 bins (i.e., 256 bins including 88 dummy bins), the next level 120 bins (i.e., 128 bins including 8 dummy bins), the next level 56 bins (i.e., 64 bins including 8 dummy bins), the next level 32 bins, and the lowest level 16 bins, respectively.

Here, the reason why 168 color histogram bins are used instead of 256 histogram bins (i.e., 4-bit non-linear quantization) is that the quantization levels of that extent (i.e., 168 bins) is enough for the image search according to the empirical rule of the image search.

Meanwhile, FIG. 1 shows the case that the HMMD color space is divided into 4 subspaces SSg, SS1, SS2, and SS3 based on a chroma parameter, and the subspaces are different from one another in quantization depth.

Summarizing to the operation of FIG. 1, an initial histogram bins of the highest level is produced, the histogram bins of the lower level are produced using the addition and subtraction operators to the histogram bins of the highest level, and then the histogram bins of the lower level are used as an addition or subtraction resource for producing the histogram bins of the next lower level.

In the embodiment of the present invention, 16 quantization coefficients are finally obtained as the encoding result, and then the final result is obtained by modulating the 16 coefficients by 4 steps using the addition (+) and subtraction (−) operators (See FIG. 2).

Accordingly, even in case that the data histogram to be searched is interrupted during its transmission due to the network problems, fair level of original image information can be restored because the histogram bins already transmitted includes (or reflects) the information on the histogram not yet transmitted. For example, even if the information on the 16 bins of the lowest level is fist transmitted, but the information on the 32 bins of the next level is not yet transmitted, the original image can be almost thoroughly restored since already transmitted 16 bins has been derived from the quantization result of its upper level.

Further step of color histogram encoding according to the present embodiment is to perform a uniform quantization of the coefficients.

The 256 coefficients finally encoded are uniform-quantized according to the bit number given by quantization offsets. At this time, the quantization offset number and the bit number are determined according to the quantization table of FIG. 3. The quantization offsets are obtained by analyzing a certain image dataset, and the dataset used at that time is prepared by constructing a dataset representative of a certain purpose. The offsets are determined differently in accordance with the bit number assigned to the coefficients.

Here, a center value of the corresponding coefficient range of the whole dataset is used for the coefficients less than 4 bits, and a mean value of the corresponding coefficient values of the whole dataset is used for other coefficients exceeding 4 bits, such that increase efficiency of the search.

The method of color histogram matching according to the present invention comprises the steps of: comparing bins of whole query image and bins of whole target image and obtaining the difference there between; constructing subsets based upon the obtained differences; and constructing the scalable-encoded color histogram in the form of a progressive bit stream, starting from its lower level through upper level

The histogram (image) matching is basically performed in the encoded state. However, it may be performed with respect to the original histogram that is restored by decoding the encoded histogram. The decoding is performed in a manner that the above-described operators are applied in an opposite order to restore the initial histogram value.

Basically, the color histogram matching method according to the present embodiment compares the bins of the whole query image with the bins of the whole target image, i.e., and obtains the difference there between.

At this time, the subset matching is performed in the order of:

Selective matching of 16 coefficients among the whole 256 coefficients corresponding to the 16-bin histogram;

Selective matching of 32 coefficients among the whole 256 coefficients corresponding to the 32-bin histogram;

Selective matching of 56 coefficients among the whole 256 coefficients corresponding to the 56-bin histogram and 8 dummy coefficients;

Selective matching of 120 coefficients among the whole 256 coefficients corresponding to the 120-bin histogram and 8 dummy coefficients; and

Selective matching of 168 coefficients among the whole 256 coefficients corresponding to the 168-bin histogram and 88 dummy coefficients.

At this time, selected coefficients are shown in FIG. 3.

As described above, the bit stream becomes progressive so that 16, 32, 64, 128, and 256 coefficients are successively matched. That is, for the progressive matching, 16, 32, 64, 128, and 256 coefficients are successively matched from the head of the bit stream to construct the progressive bit stream.

By this process, the image search (i.e., matching) can be thoroughly effective using the color histogram bin information in the head of the bit stream even if the bit stream of the color histogram is interrupted during its transmission.

The color histogram encoding method proposed according to the present invention can simulate any type of color quantization. The described scalable color histogram encoding scheme can be applied in any HMMD color quantization scheme to encode and decode it back.

For example, in case that three bins a, b, and c of the same level are requantized to one bin d, the encoding is performed in a manner that a bin a+b of the second level is prepared by adding the two bins a and b, and then the bin d (d=a+b+c) of the third level is prepared by adding the bin a+b of the second level and the bin c.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A scalable encoding method of a color histogram comprising:
producing initial color histogram bins of a relatively upper level; and
producing color histogram bins of a relatively lower level by applying predetermined operators to the color histogram bins of the upper level,
wherein the upper level of color histogram bins and the lower level of color histogram bins modified and produced from the upper level of color histogram bins at each intermediate encoding step have different encoding depths.

2. The method of claim 1, further comprising:
adding dummy bins to the initial color histogram bins of the upper level for applying a scalable encoding scheme.

3. The method of claim 1 , wherein the operators used to produce the color histogram bins of the lower level are addition operation and subtraction operations with respect to values of the color histogram bins of the upper level.

4. The method of claim 1, further comprising:
uniform-quantizing a scalable-encoded color histogram coefficients in accordance with the number of bits given by quantization offsets.

5. The method of claim 4, wherein the quantization offset is determined by analyzing certain image dataset which is obtained by constructing an image dataset representative of certain purpose.

6. The method of claim 5, wherein the quantization offset is determined based upon the number of bits assigned to quantization coefficients, wherein a center value of the corresponding coefficient range of the whole image dataset is used if the assigned number of bits is less than predetermined threshold, and a mean value of the corresponding coefficient values of the whole dataset is used if the assigned number of bits exceeds the predetermined threshold.

7. The method of claim 6, wherein the predetermined threshold is 4 bits.

8. A method of matching a scalable-encoded color histogram in a multimedia search using the color histogram, the method comprising:
comparing bins of whole query image and bins of whole target image and obtaining the difference there between;
constructing subsets based upon the obtained differences; and
constructing the scalable-encoded color histogram in the form of a progressive bit stream, starting from its lower level through upper level.

9. The method of claim 8, wherein the subset matching is progressively performed in the order of:
selective matching of 16 coefficients among the whole 256 coefficients corresponding to the 16-bin histogram;
selective matching of 32 coefficients among the whole 256 coefficients corresponding to the 32-bin histogram;
selective matching of 56 coefficients among the whole 256 coefficients corresponding to the 56-bin histogram and 8 dummy coefficients;
selective matching of 120 coefficients among the whole 256 coefficients corresponding to the 120-bin histogram and 8 dummy coefficients; and
selective matching of 168 coefficients among the whole 256 coefficients corresponding to the 168-bin histogram and 88 dummy coefficients.

10. A scalable encoding method of color histogram based on a HMMD color space, comprising:
constructing 168-bin HMMD color histogram as an initial color histogram applying 4-bit non-uniform bin quantization;
adding 88 dummy bins to the initial 168-bin color histogram to construct a scalable encoding scheme; and
performing an uniform quantization of encoded 256 coefficients based on the number of bits predetermined by a quantization offset.

11. The method according to claim 10, wherein the non-uniform bin quantization to construct 168-bin HMMD color histogram is performed by dividing HMMD color space into 4 subspaces of SSg(subspace gray), SS1, SS2 and SS3 based on “chroma” (diff: colorful) parameter.

12. The method according to claim 11, wherein cut points for dividing 4 subspaces are 9, 29, 75, respectively when the range is 0 to 255.

13. The method according to claim 11, wherein uniform color quantization for respective subspaces is further applied to construct 168-bin color histogram as follows:
SSg: hue: 1, chroma(diff): 1, intensity(sum): 8
SS1: hue: 8, chroma(diff): 1, intensity(sum): 4
SS2: hue: 16, chroma(diff): 1, intensity(sum): 4
SS3: hue: 16, chroma(diff): 1, intensity(sum): 4

14. The method according to claim 11, wherein the color histogram for each quantization level (120, 56, 32 and 16 bins) is described as follows:
120 histogram:
SSg: hue: 1, chroma(diff): 1, intensity(sum): 8
SS1: hue: 4, chroma(diff): 1, intensity(sum): 4
SS2: hue: 8, chroma(diff): 1, intensity(sum): 4
SS3: hue: 16, chroma(diff): 1, intensity(sum): 4
56 histogram:
SSg: hue: 1, chroma(diff): 1, intensity(sum): 8
SS1: hue: 4, chroma(diff): 1, intensity(sum): 4
SS2: hue: 4, chroma(diff): 1, intensity(sum): 4
SS3: hue: 4, chroma(diff): 1, intensity(sum): 4
32 histogram:
SSg: hue: 1, chroma(diff): 1, intensity(sum): 8
SS12: hue: 4, chroma(diff): 1, intensity(sum): 4
(SS1 and SS2 are merged into SS12)
SS3: hue: 4, chroma(diff): 1, intensity(sum): 2
16 histogram:
SSg: hue: 1, chroma(diff): 1, intensity(sum): 4
SS1: hue: 4, chroma(diff): 1, intensity(sum): 2
SS3: hue: 4, chroma(diff): 1, intensity(sum): 1

15. The method according to claim 14, wherein the 16 sum coefficients are further transformed without rearranging index order to obtain one sum coefficient and other 254 coefficients finally.
